(19) United States
(12) Patent Application Publication
(10) Pub. No.: US 2008/0306415 A1
(43) Pub. Date: Dec. 11, 2008

(54) Therapeutic device

(76) Inventor: Man-Yan Chan, Kowloon (HK)

Correspondence Address: ALIX YALE & RISTAS LLP, 750 MAIN STREET, SUITE 1400, HARTFORD, CT, 06103, US

(21) Appl. No.: 11/811,127

(22) Filed: Jun. 8, 2007

(51) Int. Cl. A61H 23/02

(52) U.S. Cl. 601/93

(57) ABSTRACT

A handheld device includes a casing, a motor housed within the casing and a massage member having a longitudinal pivot axis and a surface for bearing against a user's skin which is spaced radially from the pivot axis. The massage member is driven by the motor for pivotal oscillation about that axis.

### BACKGROUND OF THE INVENTION

The present invention relates to a therapeutic device for application to the skin of a user to manipulate body fat therebeneath. More particularly, although not exclusively, the invention relates to a handheld, battery operated device for applying a physical oscillatory motion to the skin of a user. Such a device might be said to provide some slimming effect.

### OBJECTS OF THE INVENTION

It is an object of the present invention to provide an improved handheld therapeutic device for inducing an oscillating motion to the skin.

### DISCLOSURE OF THE INVENTION

There is disclosed herein a handheld device, comprising:
a casing,
a motor housed within the casing,
a massage member having a longitudinal pivot axis and a surface for bearing against a user's skin and spaced radially from the pivot axis, the massage member being driven by the motor for pivotal oscillation about that axis.

Preferably, the device further comprises a geartrain driven by the motor, the geartrain transmitting rotational output of the motor to pivotal movement of the massage member.

Preferably, the device further comprises a second massage member having a longitudinal pivot axis spaced from and parallel to the pivot axis of the first said massage member and a surface for bearing against the user's skin, the respective massage members being driven by the geartrain to oscillate out of phase with respect to one another.

### BRIEF DESCRIPTION OF THE DRAWINGS

A preferred form of the present invention will now be described by way of example with reference to the accompanying drawings, wherein:

FIG. 1 is a schematic cross-sectional side elevation of a handheld therapeutic device,

FIG. 2 is a schematic cross-sectional front elevation of the device of FIG. 1,

FIG. 3 is another schematic cross-sectional front elevation of the device of FIG. 1, and

FIG. 4 is a schematic cross-sectional end elevation of the device of the preceding figures.

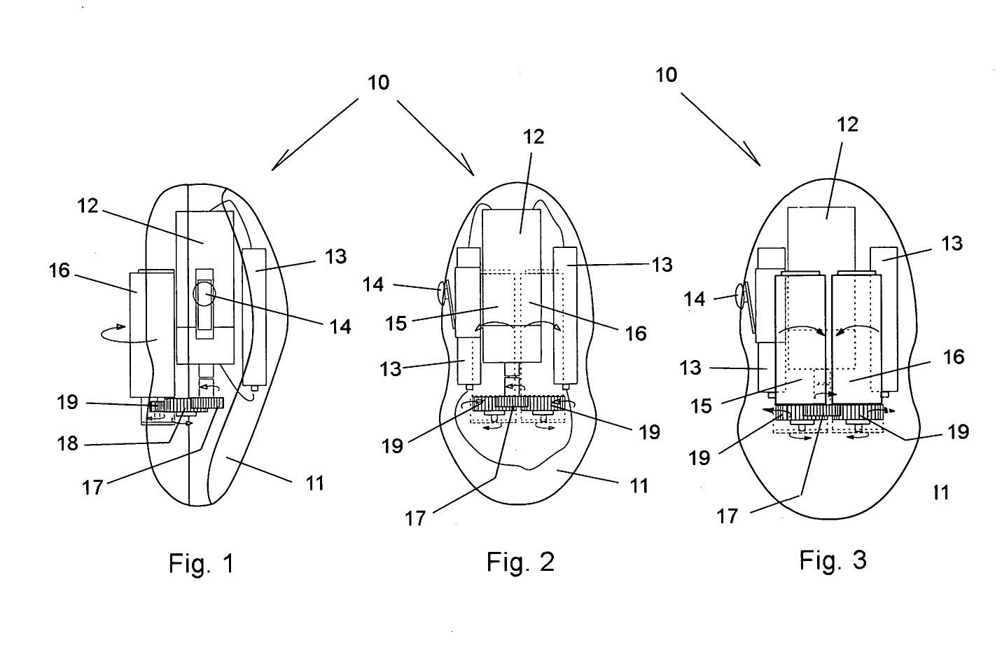

### DESCRIPTION OF THE PREFERRED EMBODIMENT

In the accompanying drawings there is depicted schematically a handheld therapeutic device 10. The device 10 includes a casing 11 typically formed as a moulded plastics enclosure of one or more parts. The casing 11 houses a motor 12 and one or more batteries 13. The motor 12 is connected electrically with the batteries 13 via an externally activated switch 14 presenting at the surface of the casing.

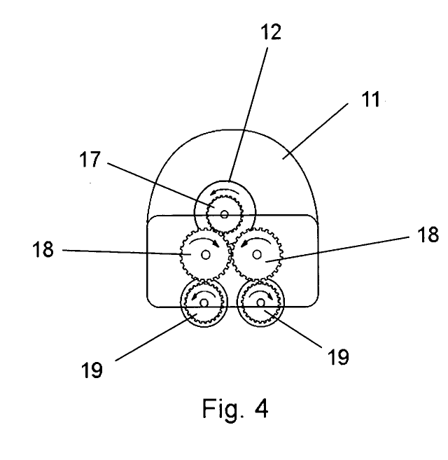

Presented at and projecting slightly proud of one side of the casing 11 is a pair of massaging members in the form of rollers 15 and 16. Each roller is mounted to the casing to pivot back and forth about a longitudinal axis of the respective roller. At one end of each roller there is affixed thereto a roller gear 19 forming part of a geartrain from the output shaft of the motor 12. Moreover, the output shaft of the motor 12 has fixed thereto a motor gear 17 coupled via a pair of intermediate gears 18 to the respective roller gears 19. Rotational directions are indicated by the various curved arrows in the drawings. With reference to FIG. 4, the motor gear 17 engages with one only of the intermediate gears 18. That intermediate gear 18 drives one of the roller gears 19 and the other intermediate gear 18. The other intermediate gear then drives the other roller gear 19. As the motor 12 oscillates back and forth by electronic control (not shown), the rollers are caused to oscillate in opposite senses.

In use, the rollers 15 and 16 are placed in contact against the user's skin—typically at an area of underlying fat. Depression of switch 14 activates motor 12 to cause pivotal out of phase reciprocation of rollers 15 and 16 against the user's skin. This will draw a portion of the user's skin and underlying fat layer by a pinching action into the region between the two rollers and release the skin repeatedly.

It should be appreciated that modifications and alterations obvious to those skilled in the art are not to be considered as beyond the scope of the present invention. For example, rather than providing a geartrain between the output shaft of the motor and the massage members, a cam and cam follower or wobble plate arrangement could be provided for transferring rotary output of a motor to pivotal oscillation of the massage members. Furthermore, rather than being powered by internal batteries, power could be provided from an external AC or DC source.

1. A handheld device, comprising:
a casing,
a motor housed within the casing,
a massage member having a longitudinal pivot axis and a surface for bearing against a user's skin and spaced radially from the pivot axis, the massage member being driven by the motor for pivotal oscillation about that axis.

2. The device of claim 1, further comprising a geartrain driven by the motor, the geartrain transmitting rotational output of the motor to pivotal movement of the massage member.

3. The device of claim 2, comprising a second massage member having a longitudinal pivot axis spaced from and parallel to the pivot axis of the first said massage member and a surface for bearing against the user's skin, the respective massage members being driven by the geartrain to oscillate out of phase with respect to one another.

4. The device of claim 1, further comprising a battery located within the casing and a switch connected electrically between the battery and the motor.
